(19) United States
(12) Patent Application Publication
(10) Pub. No.: US 2025/0292127 A1
(43) Pub. Date: Sep. 18, 2025

(54) INFORMATION PROCESSING APPARATUS, INFORMATION PROCESSING METHOD, AND PROGRAM

(71) Applicant: NIPPON TELEGRAPH AND TELEPHONE CORPORATION, Tokyo (JP)

(72) Inventors: Hideaki KIN, Musashino-shi (JP); Tetsuya KINEBUCHI, Musashino-shi (JP); Taichi ASAMI, Musashino-shi (JP)

(73) Assignee: NIPPON TELEGRAPH AND TELEPHONE CORPORATION, Tokyo (JP)

(21) Appl. No.: 18/860,022

(22) PCT Filed: May 26, 2022
(86) PCT No.: PCT/JP2022/021605

§ 371 Date: Oct. 25, 2024

(51) Int. Cl. G06N 7/01

(52) U.S. Cl. CPC G06N 7/01

(57) ABSTRACT

An information processing apparatus according to an aspect of the present invention includes a processor and a storage. The storage includes a first storage area and a second storage area. The first storage area stores event occurrence data related to the occurrence position of the event to be analyzed. The second storage area stores covariate data observed in the observation region of the event. The processor includes a kernel function designation unit, a calculation method designation unit, and an intensity function estimation unit. The kernel function designation unit receives designation of a kernel function in the Gaussian process. The calculation method designation unit receives designation of a calculation method of an equivalent kernel function. The intensity function estimation unit calculates an equivalent kernel function on the basis of the designated kernel function and calculation method, and estimates the intensity function for the covariate using the calculated equivalent kernel function.

### FIELD

An aspect of the present invention relates to an information processing apparatus, an information processing method, and a program for estimating an event occurrence probability (intensity function) for a covariate on the basis of an event occurrence position and data regarding the covariate.

### BACKGROUND OF THE INVENTION

Consider a situation in which a point event (hereinafter, referred to as an event) stochastically occurs in a space in which a covariate is defined at any point. This situation can be expressed as, for example, (space, covariate, observation data)=(latitude/longitude, crowd density, occurrence position of accident event). As a technology of estimating the probability of occurrence of an event (also referred to as an intensity function) with respect to a covariate, a technology using a kernel density estimation method is known (see, for example, Non Patent Literature 1).

Meanwhile, in recent years, a method capable of providing higher accuracy than the kernel density estimation method has been reported. For example, it is known that a Bayesian estimation method using a Gaussian process as a prior distribution achieves higher accuracy than a kernel density estimation method (see, for example, Non Patent Literatures 2 and 3).

### CITATION LIST

### Non Patent Literature

[Non Patent Literature 1] Baddeley et al., “Nonparametric estimation of the dependence of a spatial point process on spatial covariates”, Statistics and Its Interface, 5, pp. 221-236, 2012.

[Non Patent Literature 2] Lloyd et al., “Variational inference for Gaussian process modulated Poisson processes”, ICML2015, 2015.

[Non Patent Literature 3] Donner et al., “Efficient Bayesian inference for a Gaussian process density model”, UAI, 1, pp. 53-62, 2018.

### SUMMARY

### Technical Problem

A technology using the kernel density estimation method for estimating an intensity function for a covariate is known. However, a technology capable of using a Bayesian estimation method with a Gaussian process as a prior distribution, which can be expected to have higher accuracy than the kernel density estimation method, has not been known yet.

The present invention has been made in view of the above circumstances, and an object thereof is to provide a technology capable of estimating an intensity function for a covariate using a Bayesian estimation method with a Gaussian process as a prior distribution.

### Solution to Problem

An information processing apparatus according to an aspect of the present invention includes a processor and a storage unit. The storage unit includes a first storage area and a second storage area. The first storage area stores event occurrence data related to the occurrence position of the event to be analyzed. The second storage area stores covariate data observed in the observation region of the event. The processor includes a kernel function designation unit, a calculation method designation unit, and an intensity function estimation unit. The kernel function designation unit receives designation of a kernel function in the Gaussian process. The calculation method designation unit receives designation of a calculation method of an equivalent kernel function. The intensity function estimation unit calculates an equivalent kernel function on the basis of the designated kernel function and calculation method, and estimates the intensity function for the covariate using the calculated equivalent kernel function.

### Advantageous Effects of Invention

According to an aspect of the present invention, it is possible to provide a technology capable of estimating an intensity function for a covariate on the basis of a Bayesian estimation method with a Gaussian process as a prior distribution.

### BRIEF DESCRIPTION OF DRAWINGS

FIG. 1 is a functional block diagram illustrating an example of an information processing apparatus according to an embodiment.

FIG. 2 is a functional block diagram illustrating an example of the information processing apparatus 1 illustrated in FIG. 1. FIG. 3 is a flowchart illustrating an example of processing procedures of the information processing apparatus 1 illustrated in FIG. 1.

### DETAILED DESCRIPTION

Hereinafter, embodiments according to the present invention will be described with reference to the drawings.

### Configuration

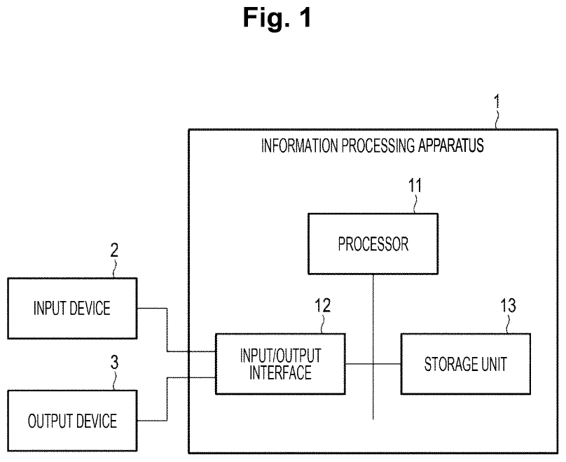

FIG. 1 is a functional block diagram illustrating an example of an information processing apparatus according to an embodiment.

An information processing apparatus 1 is a computer including a processor and a memory. The information processing apparatus 1 includes a processor 11, an input/output interface 12, and a storage unit 13. The processor 11, the input/output interface 12, and the storage unit 13 are communicably connected to each other via a bus.

The processor 11 controls the information processing apparatus 1. The processor 11 is an arithmetic device such as a central processing unit (CPU) or a micro processing unit (MPU).

The input/output interface 12 is an interface that enables transmission and reception of information between an input device 2 and an output device 3. The input/output interface 12 may include a wired or wireless communication interface. That is, the information processing apparatus 1, the input device 2, and the output device 3 may transmit and receive information via a network such as a LAN or the Internet.

The storage unit 13 is a storage medium. The storage unit 13 includes a nonvolatile memory to and from which write and read can be performed at any time, such as a hard disk drive (HDD) or a solid state drive (SSD), a nonvolatile memory such as a read only memory (ROM), and a volatile memory such as a random access memory (RAM), in combination. The storage unit 13 includes a program storage area and a data storage area in a storage area. The program storage area stores an application program necessary for executing various types of processing in addition to an operating system (OS) and middleware.

The input device 2 includes, for example, a keyboard, a pointing device, and the like for an owner (for example, an allocator, an administrator, a supervisor, or the like) of the information processing apparatus 1 to input an instruction to the information processing apparatus 1. Further, the input device 2 can include a reader for reading data to be stored in the storage unit 13 from a memory medium such as a USB memory, and a disk device for reading such data from a disk medium. Moreover, the input device 2 may include an image scanner.

The output device 3 includes a display that displays output data to be presented from the information processing apparatus 1 to the owner, a printer that prints the output data, and the like. Further, the output device 3 can include a writer for writing data to be input to another information processing apparatus 1 such as a PC or a smartphone to a memory medium such as a USB memory, and a disk device for writing such data to a disk medium.

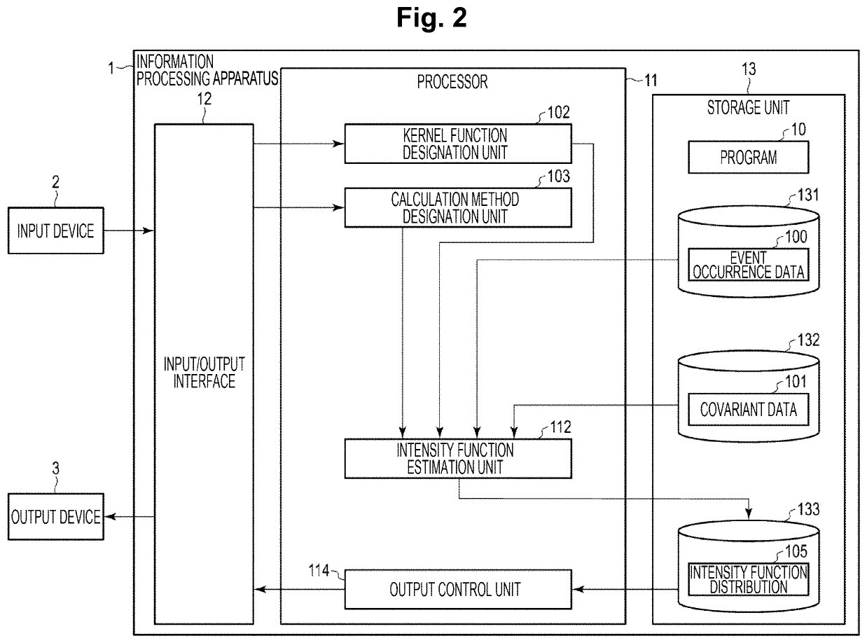

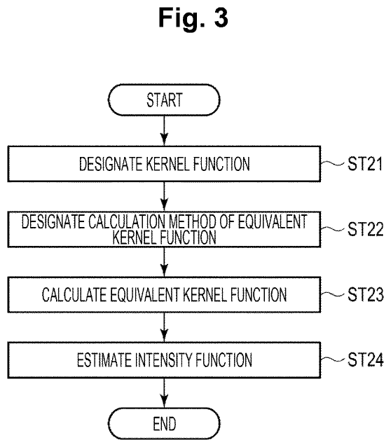

FIG. 2 is a functional block diagram illustrating an example of the information processing apparatus 1 illustrated in FIG. 1. In FIG. 2, the storage unit 13 stores a program 10 that causes the processor 11 to function as the information processing apparatus 1. The storage unit 13 includes a first storage area 131, a second storage area 132, and a third storage area 133.

The first storage area 131 stores event occurrence data 100. The event occurrence data 100 is data related to an occurrence position of an event to be analyzed, and includes at least the number of times of the observed event, a sequence of event positions, and an observation region.

The second storage area 132 stores covariate data 101 observed in the observation region of the event to be analyzed.

The third storage area 133 stores an intensity function distribution 105 calculated by the processor 11.

The processor 11 includes a kernel function designation unit 102, a calculation method designation unit 103, an intensity function estimation unit 112, and an output control unit 114 as processing functions according to the embodiment. The kernel function designation unit 102, the calculation method designation unit 103, the intensity function estimation unit 112, and the output control unit 114 are functional processes achieved by arithmetic processing of the processor 11 based on the program 10.

The kernel function designation unit 102 receives designation of a kernel function in the Gaussian process. The kernel function is designated by the user, for example, by operating the input device 2.

The calculation method designation unit 103 receives designation of a calculation method of an equivalent kernel function. The calculation method may also be designated by the user, for example, by operating the input device 2.

The intensity function estimation unit 112 calculates an equivalent kernel function on the basis of the designated kernel function and the calculation method. The intensity function estimation unit 112 estimates the intensity function for the covariate using the calculated equivalent kernel function. The intensity function distribution 105 is stored in the third storage area 133.

The output control unit 114 outputs the intensity function distribution 105 to the output device 3 via the input/output interface 12. The output device 3 visualizes and displays the calculated intensity function distribution 105 on, for example, a display.

Next, an operation in the above configuration will be described.

### Operation

### (Outline)

First, an outline of the operation will be described. In the embodiment, the processor 11 mainly performs the processing of (1) to (4) to achieve the estimation of the intensity function for the covariate based on the Bayesian estimation method with the Gaussian process as the prior distribution.

(1) For a variable according to a Gaussian process defined in a covariate space, the square of the variable is defined as an intensity function. As a result, the estimated value of the square root of the intensity function that maximizes the posterior probability (maximum posterior probability estimation value or MAP estimation value) is given as a solution of an N-element system of equations with the number of pieces of observation data as N. This can be expressed as a case in which the Representer theorem is established. This fact makes it easy to numerically solve the estimation value of the square root of the intensity function.

(2) An estimation error of the square root of the intensity function is calculated by Laplace approximation. That is, the Hessian matrix in the MAP estimation value of the log posterior probability distribution followed by the square root of the intensity function is calculated. Then, an inverse matrix of the Hessian matrix multiplied by −1 is set as a covariance matrix of the estimation value of the square root of the intensity function.

(3) Under the Laplace approximation of (2), a gamma distribution followed by the estimation value of the intensity function is obtained. The final goal of the intensity function estimation is to obtain a probability distribution for this estimation value.

(4) A hyperparameter necessary for the estimation of the intensity function is estimated from the observation data on the basis of the empirical Bayes method. The empirical Bayes method is a method of using a hyperparameter that maximizes the peripheral likelihood as an estimation value. Representative examples of the hyperparameter include a parameter of a kernel function in a Gaussian process.

FIG. 3 is a flowchart illustrating an example of processing procedures of the information processing apparatus 1 illustrated in FIG. 1. In FIG. 3, the processor 11 receives designation of a kernel function in a Gaussian process by the user (step SST21). Next, the processor 11 receives designation of a calculation method of the equivalent kernel function by the user (step SST22).

Next, the processor 11 calculates an equivalent kernel function on the basis of the designated kernel function and the calculation method (step ST23). The processor 11 estimates the intensity function for the covariate using the calculated equivalent kernel function (step S24).

### (Details)

Next, details of the operation will be described with reference to a mathematical expression.

### [Regarding Event Occurrence Data]

Data on the occurrence position of the event to be analyzed is given as an input. The event occurrence data includes the following (A), (B), and (C).

$$[ Math . 1 ]$$

$$Number of times of observed \text{event:} N \qquad ( A )$$

$$Sequence of event \text{positions:} \{ {S}_{n} \} ≡ ( {S}_{1} , … , {S}_{N} ) \qquad ( B )$$

$$\text{Observation region:} T ( C )$$

Where, the number of dimensions of the space in which the event occurs is arbitrary, and for example, time is considered in the case of one-dimensional, geographic space is considered in the case of two-dimensional, and spatiotemporal space is considered in the case of three-dimensional.

### [Regarding Covariate Data]

The data of the covariate observed in the observation region T (Expression (C)) of the event is given as a function (Expression (E)) that outputs the covariate with any point (Expression (D)) in the observation region (Expression (C)) as an input. In many applications, information on covariates is obtained only on a finite number of points in the observation region (Expression (C)). In that case, it is assumed that the function (Expression (E)) is constructed using an interpolation technology such as a regression model or Kriging.

$$[ Math . 2 ]$$

$$t ∈ T \qquad ( D )$$

$$y ( t ) \qquad ( E )$$

### Regarding [Designation of Kernel Function in Gaussian Process]

In order to use the Gaussian process, a function called a kernel function that determines smoothness of a function to be modeled is designated. The value of the parameter (hyperparameter) included in the function is also designated at the same time.

The function to be modeled in the embodiment is an intensity function for a covariate. The kernel function for any two points (Expression (F)) in the covariate space is expressed as (Expression (G)).

$$[ Math . 3 ]$$

$$( {y}^{′} , y ) \qquad ( F )$$

$$k ( {y}^{′} , y ) \qquad ( G )$$

As an example of the kernel function, a Gaussian kernel given by Expression (1) can be mentioned.

$$[ \text{Math.} 4 ]$$

$$k ( {y}^{′} , y ) = exp ( - {\vert {y}^{′} - y \vert}^{2} / {c}^{2} ) \qquad ( 1 )$$

Alternatively, examples of the kernel function include the kernel of the Expression (2) expressed by the inner product of the finite-dimensional feature mapping vector (Expression (H)).

$$[ \text{Math.} 5 ]$$

$$( {ϕ}_{1} ( y ) , {ϕ}_{2} ( y ) , … , {ϕ}_{L} ( y ) ) \qquad ( H )$$

$$k ( {y}^{′} , y ) = {\sum }_{l = 1}^{L} {ϕ}_{l} ( y ) {ϕ}_{l} ( {y}^{′} ) \qquad ( 2 )$$

### Regarding [Designation of Calculation Method of Equivalent Kernel Function]

A method of calculating an equivalent kernel function is given as an input. The method for calculating the equivalent kernel function includes the type of calculation method and points of Monte Carlo integration (Expression (I)).

$$[ \text{Math.} 6 ]$$

$$Points of Monte Carlo \text{integration:} M \qquad ( I )$$

The options of the types of calculation methods are type 1 and type 2, and type 2 can be selected only when the kernel function is given by an inner product of a finite dimensional feature mapping vector.

### Regarding [Estimation of Intensity Function]

The processor 11 calculates an equivalent kernel function (Expression (J)) on the basis of the information given above.

$$[ \text{Math.} 7 ]$$

$$Equivalent kernel \text{function :} h ( y , {y}^{′} ) \qquad ( J )$$

Then, the processor 11 estimates an intensity function (Expression (K)) for the covariate using the equivalent kernel function (J).

$$[ \text{Math.} 8 ]$$

$$Intensity \text{function:} λ ( y ) \qquad ( K )$$

First, the equivalent kernel function (Expression (J)) is defined as a solution to the integral equation of Expression (3).

$$[ \text{Math.} 9 ]$$

$$h ( y , {y}^{′} ) + 2 {\int }_{T} k ( y , y ( t ) ) h ( y ( t ) , {y}^{′} ) dt = k ( y , {y}^{′} ) \qquad ( 3 )$$

In preparation for numerically solving the integral equation, the integral part is approximated by Monte Carlo integration to obtain Expression (4).

$$[ \text{Math.} 10 ]$$

$$h ( y , {y}^{′} ) + 2 \frac{\vert T \vert}{M} {\sum }_{m = 1}^{M} k ( y , {y}_{m} ) h ( {y}_{m} , {y}^{′} ) = k ( y , {y}^{′} ) \qquad ( 4 )$$

Where, (Expression (L)) is a covariate on the m-th sample point.

$$[ \text{Math.} 11 ]$$

$${y}_{m} = y ( {t}_{m} ) \qquad ( L )$$

When type 1 is designated as the type of the calculation method, the equivalent kernel function (Expression (N)) is obtained as in Expression (5) by solving Expression (4) as a matrix equation related to the vertical vector function (Expression (M)).

$$[ \text{Math.} 12 ]$$

$${h}_{M} ( y ) = {( h ( y , {y}_{1} ) , … , h ( y , {y}_{M} ) )}^{T} \qquad ( M )$$

$$Equivalent kernel \text{function:} {h}_{{type}_{-} 1} ( y , {y}^{′} ) \qquad ( N )$$

$${h}_{{type}_{-} 1} ( y , {y}^{′} ) = k ( y , {y}^{′} ) - 2 \frac{\vert T \vert}{M} {{k}_{M} ( y )}^{T} {( {I}_{M} + 2 \frac{\vert T \vert}{M} K )}^{- 1} {k}_{M} ( {y}^{′} ) \qquad ( 5 )$$

Where,
I_{M}: M-dimensional identity matrix
K: Gram matrix
k_{M}(y): Column vector k_{M}(y)=(k(y,y₁), . . . , k(y,y_{M}))^{τ}

When type 2 is designated as the type of the calculation method, the equivalent kernel function (Expression (O)) is obtained in the form of Expression (6) from Expression (4) on the assumption that the kernel function is given by the inner product of the finite dimensional feature mapping vector as in Expression (2).

$$[ \text{Math.} 13 ]$$

$$Equivalent kernel \text{function:} {h}_{{type}_{-} 2} ( y , {y}^{′} ) \qquad ( O )$$

$${h}_{{type}_{2}} ( y , {y}^{′} ) = {ϕ ( y )}^{T} {( {I}_{L} + 2 A )}^{- 1} ϕ ( {y}^{′} ) , {A}_{{u}^{′}} = \frac{\vert T \vert}{M} {\sum }_{m = 1}^{M} {ϕ}_{l} ( {y}_{m} ) {ϕ}_{{l}^{′}} ( {y}_{m} ) \qquad ( 6 )$$

Where,
L: Number of dimensions of feature mapping vector
I_{L}: L-dimensional identity matrix
ϕ(y): Column vector ϕ(y)=(ϕ₁(y), . . . , ϕ_{L}(y))^{τ}

Next, a MAP estimation value of the square root of the intensity function is calculated by Expression (7) using the equivalent kernel function (Expression (J)).

$$[ \text{Math.} 14 ]$$

$$μ ( y ) = 2 {\sum }_{n = 1}^{N} h ( y , y ( {s}_{n} ) ) \cdot {z}_{n} \qquad ( 7 )$$

Where, (Expression (P)) is obtained by solving the following simultaneous equation (8).

$$[ \text{Math.} 15 ]$$

$${\{ {Z}_{n} \}}_{n = 1}^{N} \qquad ( P )$$

$$\begin{matrix}2 {z}_{{n}^{′}} {\sum }_{n = 1}^{N} h ( y ( {s}_{{n}^{′}} ) , y ( {s}_{n} ) ) \cdot {z}_{n} = 1 , & {n}^{′} = 1 , … N\end{matrix} \qquad ( 8 )$$

Next, under Laplace approximation, it is assumed that the square root of the intensity function follows a normal distribution with the MAP estimation value as an average, and a covariance matrix (Expression (Q)) thereof is calculated by Expression (9).

$$[ \text{Math.} 16 ]$$

$$Covariance \text{matrix:} σ ( y , {y}^{′} ) \qquad ( Q )$$

$$σ ( y , {y}^{′} ) = h ( y , {y}^{′} ) - {{h}_{N} ( y )}^{T} {( Z + H )}^{- 1} {h}_{N} ( {y}^{′} ) \qquad ( 9 )$$

Where, Expression (10) holds.

$$[ \text{Math.} 17 ]$$

$$\begin{matrix}{h}_{N} ( y ) = {( h ( y , y ( {s}_{1} ) ) , … , h ( y , y ( {s}_{N} ) ) )}^{T} , \\ {Z}_{{nn}^{′}} = \{ \begin{matrix}0 & : n \neq {n}^{′} \\ {z}_{n}^{- 2} / 2 & : n = {n}^{′}\end{matrix} , {H}_{{nn}^{′}} = h ( y ( {s}_{n} ) , y ( {s}_{{n}^{′}} ) ) , 1 \leq n , {n}^{′} \leq N\end{matrix} \qquad ( 10 )$$

Finally, the probability distribution followed by the estimation value of the intensity function at each covariate value (Expression (R)) is calculated as a gamma distribution in which the scale parameter (Expression(S)) and the shape parameter (Expression (T)) are each given by Expression (11).

$$[ \text{Math.} 18 ]$$

$$Covariate \text{value:} y \qquad ( R )$$

$$Scale \text{parameter:} α ( y ) \qquad ( S )$$

$$Shape \text{parameter:} γ ( y ) \qquad ( T )$$

$$α ( y ) = 2 \frac{2 {μ ( y )}^{2} σ ( y ) + {σ ( y )}^{2}}{{μ ( y )}^{2} + σ ( y )} , γ ( y ) = \frac{{( {μ ( y )}^{2} + σ ( y ) )}^{2}}{2 σ ( y ) ( 2 {μ ( y )}^{2} + σ ( y ) )} \qquad ( 11 )$$

In the processing of [Estimation of Intensity Function], the validity of the hyperparameter designated in [Designation of Kernel Function in Gaussian Process] can be evaluated on the basis of the peripheral likelihood function. Furthermore, when the hyperparameter is optimized, the hyperparameter that maximizes the peripheral likelihood function is searched for, and Expression (11) is recalculated using the value.

### Regarding [Estimated Intensity Function Distribution]

The probability distribution of the intensity function calculated in [Estimation of Intensity Function] is output. What is output is a function that outputs, for any covariate value (Expression (R)), a value of a gamma distribution having a scale and shape parameters given by Expression (11).

### Effects

As described above, according to the embodiment, it is possible to estimate the intensity function for the covariate using the Bayesian estimation method with the Gaussian process as the prior distribution.

Note that the present invention is not limited to the above-described embodiment without any change. For example, the selection of the kernel function is not limited to Expression (1) or Expression (2).

This invention can be embodied by modifying the constituents without departing from the gist of the embodiment in the implementation stage. Various inventions can be made by appropriately combining a plurality of constituents disclosed in the above embodiment. For example, some constituents may be omitted from the entire constituent elements described in the embodiments. Further, configurational elements from different embodiments may be appropriately combined.

### REFERENCE SIGNS LIST

1 Information processing apparatus
2 Input device
3 Output device
10 Program
11 Processor
12 Input/output interface
13 Storage unit
131 First storage area
132 Second storage area
133 Third storage area
100 Event occurrence data
101 Covariate data
102 Kernel function designation unit
103 Calculation method designation unit
105 Intensity function distribution
112 Intensity function estimation unit
114 Output control unit

1. An information processing apparatus comprising a processor and a storage unit,
the storage unit including
a first storage area that stores event occurrence data related to an occurrence position of an event to be analyzed, and
a second storage area that stores covariate data observed in an observation region of the event,
the processor including
a kernel function designation unit that receives designation of a kernel function in a Gaussian process,
a calculation method designation unit that receives designation of a calculation method of an equivalent kernel function, and
an intensity function estimation unit that calculates the equivalent kernel function based on the kernel function and the calculation method that have been designated, and estimates an intensity function for a covariate using the equivalent kernel function that has been calculated.

2. The information processing apparatus according to claim 1, wherein the event occurrence data includes at least the number of times of the observed event, a sequence of event positions, and an observation region.

3. The information processing apparatus according to claim 1, wherein the kernel function designation unit further receives designation of a value of a hyperparameter of the kernel function.

4. The information processing apparatus according to claim 1, wherein the calculation method designation unit receives at least designation of a type of a calculation method of the equivalent kernel function and designation of a point of Monte Carlo integration.

5. An information processing method of an information processing apparatus including a storage unit that stores event occurrence data related to an occurrence position of an event to be analyzed, and covariate data observed in an observation region of the event, and a processor,
the information processing method comprising steps of:
receiving designation of a kernel function in a Gaussian process, by the processor;
receiving designation of a calculation method of an equivalent kernel function, by the processor;
calculating the equivalent kernel function based on the kernel function and the calculation method that have been designated, by the processor; and
estimating an intensity function for a covariate using the equivalent kernel function that has been calculated, by the processor.

6. A non-transitory computer readable medium storing a program, when executed by a processor, causes the processor to function as each unit of the information processing apparatus according to claim 1.
